(19) United States
(12) Patent Application Publication
(10) Pub. No.: US 2026/0204851 A1
(43) Pub. Date: Jul. 16, 2026

(54) HIGH POWER CABLE HARNESS

(71) Applicant: BIZLINK INTERNATIONAL CORP., New Taipei City (TW)

(72) Inventors: Hongping SU, New Taipei City (TW); Yong WANG, New Taipei City (TW); Haoran ZOU, New Taipei City (TW)

(21) Appl. No.: 19/089,001

(22) Filed: Mar. 25, 2025

(30) Foreign Application Priority Data
Jan. 16, 2025 (CN) 202520107864.7

(51) Int. Cl. H01R 25/14; H01R 31/06

(52) U.S. Cl. CPC H01R 25/142; H01R 31/06

(57) ABSTRACT

A high power cable harness includes a housing, two terminal modules, and a power-supplying conductor. The housing has two protruding portions. Each of the protruding portions has an opening. The openings of the protruding portions are opposite to each other. The terminal modules are embedded into the housing. Each of the terminal modules includes an inner terminal, an outer terminal, and a conductive block. The inner terminal and the outer terminal are partially exposed from one of the openings. The conductive block is partially sandwiched between the inner terminal and the outer terminal. The power-supplying conductor is secured on a side of the outer terminal away from the inner terminal and thermally connected to the conductive block.

### CROSS-REFERENCE TO RELATED APPLICATION

This application claims priority to China Application Serial Number 202520107864.7, filed Jan. 16, 2025, which is herein incorporated by reference.

### BACKGROUND

### Technical Field

The present disclosure relates to a high power cable harness.

### Description of Related Art

At present, most high power cable harnesses solve the heat dissipation problem of terminals by increasing the contact area. For example, US patent Application Publication No. 20220263282 A1 provides an electrical connector, in which each of the two terminal assemblies includes two terminals and is thermally connected to a conductive block by one of the terminals, so as to improve the heat dissipation performance.

However, simply increasing the contact area between the one of the terminals and the conductive block is no longer able to withstand the heat energy generated by large currents (for example, current intensity greater than 200 amperes). When current flows through, the contact surface between a terminal of a high power cable harness and a corresponding terminal of the mating connector will generate a large amount of heat energy, causing the temperature around the contact surface of the terminal to rise rapidly, thereby reducing the conductive performance of the terminal.

Accordingly, how to provide a high power cable harness to solve the aforementioned problems becomes an important issue to be solved by those in the industry.

### SUMMARY

An aspect of the disclosure is to provide a high power cable harness that can efficiently solve the aforementioned problems.

According to an embodiment of the disclosure, a high power cable harness includes a housing, two terminal modules, and a power-supplying conductor. The housing includes two protruding portions. Each of the protruding portions has an opening. The openings of the protruding portions are opposite to each other. The terminal modules are embedded into the housing. Each of the terminal modules includes an inner terminal, an outer terminal, and a conductive block. The inner terminal and the outer terminal are partially exposed from one of the openings. The conductive block is partially sandwiched between the inner terminal and the outer terminal. The power-supplying conductor is secured on a side of the outer terminal away from the inner terminal and thermally connected to the conductive block.

According to an embodiment of the disclosure, a high power cable harness includes a terminal module, a power-supplying conductor, and a heat sink. The terminal module includes an inner terminal, an outer terminal, and a conductive block. The conductive block is partially sandwiched between the inner terminal and the outer terminal. The power-supplying conductor is secured on a side of the outer terminal away from the inner terminal and thermally connected to the conductive block. The heat sink is thermally coupled to the power-supplying conductor.

Accordingly, in the high power cable harness of the present disclosure, since each of the terminal modules includes the conductive block partially sandwiched between the inner terminal and the outer terminal, and the power-supplying conductor is secured on the outer terminal and thermally connected to the conductive block, a plurality of electrical/thermal conductive paths can be formed. Specifically, a first electrical/thermal conductive path passes through the inner terminal (via the top surface thereof) and the conductive block, a second electrical/thermal conductive path passes through the outer terminal (via the bottom surface thereof) and the conductive block, and a third electrical/thermal conductive path passes through the outer terminal (via the top surface thereof) and the power-supplying conductor. In this way, the electrical/thermal conductivity performance of high power cable harness can be effectively improved.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a high power cable harness according to an embodiment of the present disclosure;

FIG. 2 is another perspective view of the high power cable harness in FIG. 1;

FIG. 3 is a perspective view of some components of the high power cable harness in FIG. 1;

FIG. 4 is an exploded view of the components of the high power cable harness in FIG. 3; and

FIG. 5 is another perspective view of the components of the high power cable harness in FIG. 3.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

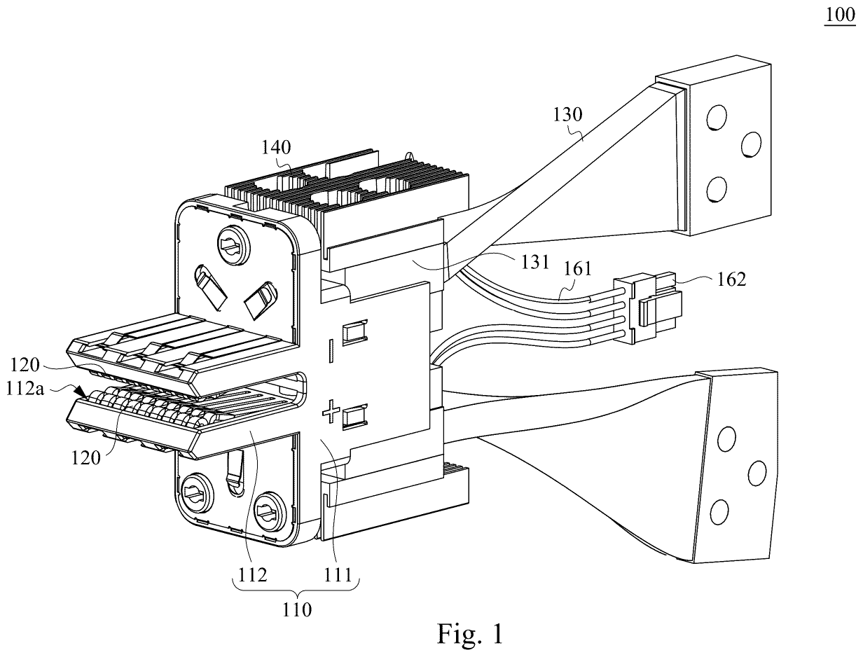

The drawings in FIGS. 1 to 5 are drawn true to scale. In order to keep the description concise, the proportions of each component are not listed one by one, but the proportions and positions of each component should be regarded as part of the content of this description.

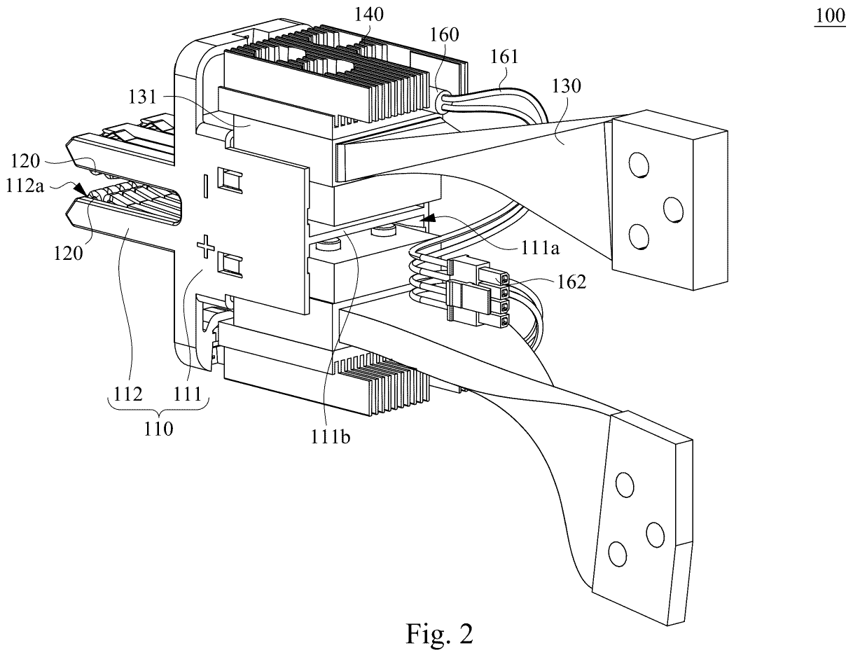

Reference is made to FIGS. 1 and 2. FIG. 1 is a perspective view of a high power cable harness 100 according to an embodiment of the present disclosure. FIG. 2 is another perspective view of the high power cable harness 100 in FIG. 1. As shown in FIGS. 1 and 2, in the present disclosure, the high power cable harness 100 includes a housing 110 and two sets of connector assemblies. The two sets of the connector assemblies may be identical and symmetrically disposed in the housing 110. The connector assemblies are partially disposed in the housing 110. Specifically, the housing 110 includes a main portion 111 and two protruding portions 112. The main portion 111 has an outlet 111a. In detail, as shown in FIG. 2, the main portion 111 includes a partition 111b that divides the outlet 111a into two sub-outlets, and the two sets of connector assemblies respectively extend out of the two sub-outlets. Each of the two sets of connector assemblies includes a terminal module 120, a metal braid 130, and a heat sink 140. Each of the protruding portions 112 of the housing 110 has an opening 112a. The openings 112a of the protruding portions 112 are opposite to each other. The terminal modules 120 are embedded into the housing 110. The metal braid 130 and a heat sink 140 are located outside the housing 110. One of the terminal modules 120 is partially exposed out of the housing 110 from one of the openings. Another of the terminal modules 120 is partially exposed out of the housing 110 from another of the openings. A slot formed between the protruding portions 112 is configured to be inserted by a rack busbar (not shown), so as to transmit power from the rack busbar to the terminal modules 120.

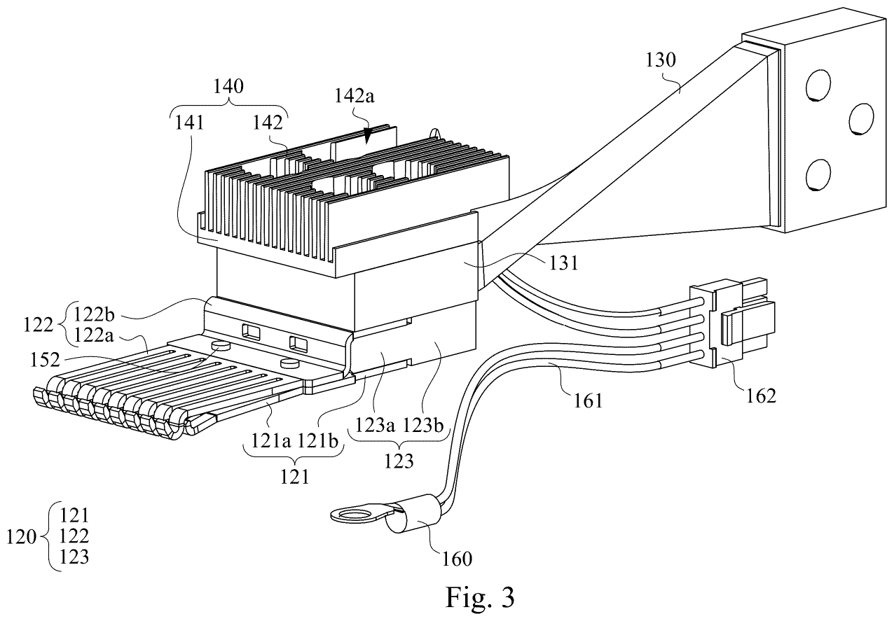

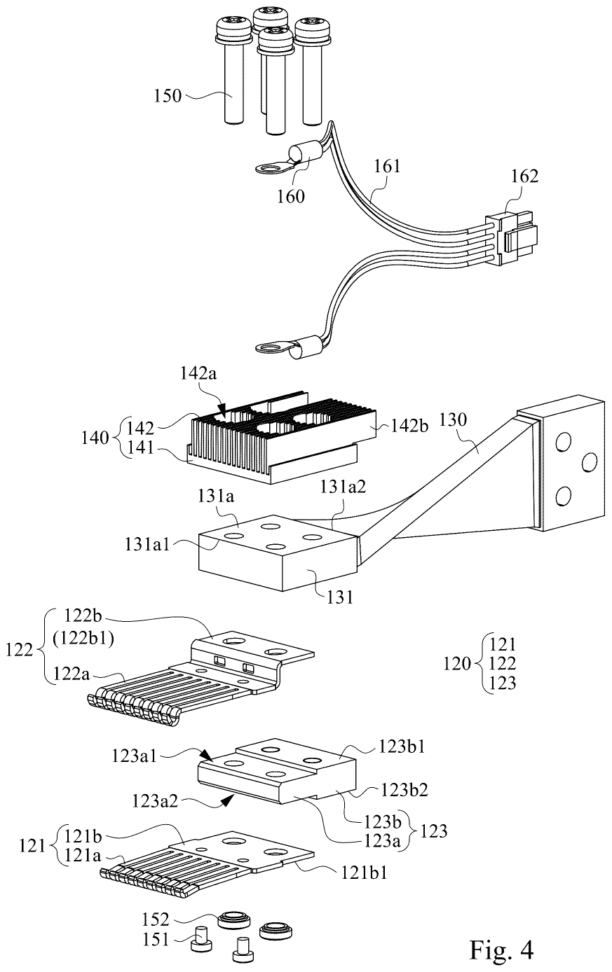

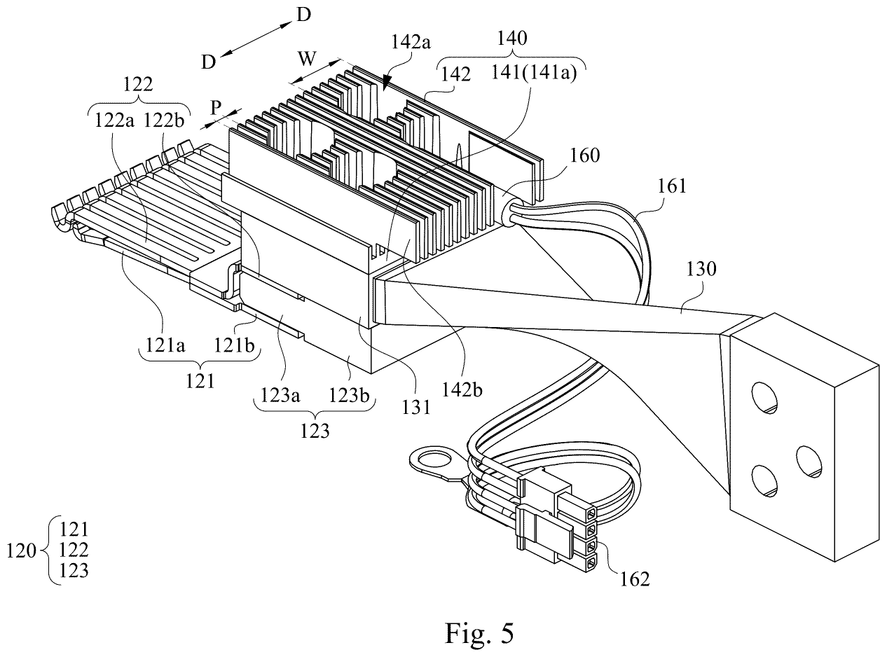

Reference is made to FIG. 3, FIG. 4, and FIG. 5. FIG. 3 is a perspective view of some components of the high power cable harness 100 in FIG. 1. FIG. 4 is an exploded view of the components of the high power cable harness 100 in FIG. 3. FIG. 5 is another perspective view of the components of the high power cable harness 100 in FIG. 3. It should be pointed out that FIGS. 3 to 5 show one set of the connector assemblies. As shown in FIGS. 3 to 5, in the present embodiment, the terminal module 120 includes an inner terminal 121, an outer terminal 122, and a conductive block 123. The inner terminal 121 and the outer terminal 122 are partially exposed from one of the openings 112a of the protruding portions 112 (with reference to FIGS. 1 and 2). The conductive block 123 is partially sandwiched between the inner terminal 121 and the outer terminal 122. The metal braid 130 includes a power-supplying conductor 131. The power-supplying conductor 131 is secured on a side of the outer terminal 122 away from the inner terminal 121 and thermally connected to the conductive block 123.

With the foregoing structural configurations, a plurality of electrical/thermal conductive paths can be formed. Specifically, a first electrical/thermal conductive path passes through the inner terminal 121 (via the top surface thereof) and the conductive block 123, a second electrical/thermal conductive path passes through the outer terminal 122 (via the bottom surface thereof) and the conductive block 123, and a third electrical/thermal conductive path passes through the outer terminal 122 (via the top surface thereof) and the power-supplying conductor 131. In this way, the electrical/thermal conductivity performance of high power cable harness 100 can be effectively improved.

As shown in FIG. 4, in the present embodiment, the inner terminal 121 includes a terminal end 121a and a base portion 121b connected to the terminal end 121a. The terminal end 121a is exposed from the one of the openings 112a, and the base portion 121b is embedded into the housing 110 (with reference to FIGS. 1 and 2). The outer terminal 122 includes a terminal end 122a and a base portion 122b connected to the terminal end 122a. The terminal end 122a is exposed from another of the openings 112a, and the base portion 122b is embedded into the housing 110 (with reference to FIGS. 1 and 2). The conductive block 123 is partially sandwiched between the base portion 121b of the inner terminal 121 and the base portion 122b of the outer terminal 122.

As shown in FIG. 4 with reference to FIG. 3, in the present embodiment, the inner terminal 121 and the outer terminal 122 are fastened to each other. Specifically, the base portion 121b of the inner terminal 121 and the base portion 122b of the outer terminal 122 are fastened to each other by screws 151, but the present disclosure is not limited thereto.

As shown in FIG. 4 with reference to FIGS. 3 and 5, in the present embodiment, the conductive block 123 includes a front portion 123a and a rear portion 123b connected to the front portion 123a. The front portion 123a is sandwiched between the base portion 121b of the inner terminal 121 and the base portion 122b of the outer terminal 122. The rear portion 123b is in contact with the power-supplying conductor 131.

As shown in FIG. 4 with reference to FIGS. 3 and 5, in the present embodiment, the conductive block 123 has a recess 123a1 on a side of the conductive block 123 facing the power-supplying conductor 131. The base portion 122b of the outer terminal 122 is located at the recess 123a1. In addition, a surface 122b1 of the base portion 122b of the outer terminal 122 away from the inner terminal 121 and a surface 123b1 of the rear portion 123b facing the power-supplying conductor 131 are coplanar. That is, a thickness of the base portion 122b of the outer terminal 122 is equal to a depth of the recess 123a1. In this way, the surface 122b1 of the base portion 122b of the outer terminal 122 and the surface 123b1 of the rear portion 123b can contact the bottom surface of the power-supplying conductor 131 at the same time.

As shown in FIG. 4 with reference to FIGS. 3 and 5, in the present embodiment, the conductive block 123 has a recess 123a2 on a side of the conductive block 123 away from the power-supplying conductor 131. The base portion 121b of the inner terminal 121 is located at the recess 123a2. In addition, a surface 121b1 of the base portion 121b of the inner terminal 121 away from the outer terminal 122 and a surface 123b2 of the rear portion 123b away from the power-supplying conductor 131 are coplanar. That is, a thickness of the base portion 121b of the inner terminal 121 is equal to a depth of the recess 123a2. In this way, the internal design of housing 110 can be simplified.

In some embodiments, the front portion 123a may be defined as a portion of the conductive block 123 that has the recess 123a1 and/or the recess 123a2, but the present disclosure is not limited thereto.

In some embodiments, the recess 123a2 of the conductive block 123 may be omitted. That is, an entirety of the bottom surface of the conductive block 123 may be flat.

As shown in FIG. 4 with reference to FIG. 3, in the present embodiment, the terminal end 121a and the base portion 121b of the inner terminal 121 are connected flatly. The terminal end 122a and the base portion 122b of the outer terminal 122 are connected curvedly. Specifically, the base portion 122b of the outer terminal 122 includes three segments connected in a zigzag manner. In other words, the base portion 122b of the outer terminal 122 is Z-shaped.

As shown in FIG. 4, the three segments of the base portion 122b are connected vertically in sequence, but the present disclosure is not limited thereto. In other embodiments, the three segments of the base portion 122b may be connected curvedly or obliquely in sequence.

In other embodiments, the terminal end 121a and the base portion 121b of the inner terminal 121 may be connected curvedly, and the terminal end 122a and the base portion 122b of the outer terminal 122 may be connected flatly.

As shown in FIG. 4 with reference to FIGS. 3 and 5, in the present embodiment, the heat sink 140 thermally coupled to the power-supplying conductor 131. Specifically, the heat sink 140 includes a conductive base 141 and a plurality of fins 142. The conductive base 141 is coupled to a surface 131a of the power-supplying conductor 131 away from the conductive block 123. The fins 142 are connected to a side of the conductive base 141 away from the power-supplying conductor 131. The heat sink 140 is configured to absorb the heat generated by the inner terminal 121 and the outer terminal 122 through the aforementioned three electrical/thermal conductive paths and discharge it to the air through the fins 142.

In some embodiments, the conductive base 141 and the fins 142 are parts of a unitary structure. In other words, the conductive base 141 and the fins 142 may be made of a metal material by, for example, an extrusion process, but the disclosure is not limited thereto.

As shown in FIG. 4 with reference to FIGS. 3 and 5, in the present embodiment, the surface 131a of the power-supplying conductor 131 has a front edge 131a1 adjacent to the outer terminal 122. The conductive base 141 partially extends beyond the front edge 131a1.

As shown in FIG. 4 with reference to FIGS. 3 and 5, in the present embodiment, the surface 131a of the power-supplying conductor 131 has a rear edge 131a2 away from the outer terminal 122. A group of the fins 142 partially extend beyond the rear edge 131a2. Specifically, each of the group of the fins 142 has a rear extending portion 142b. The rear extending portion 142b is not directly connected to the conductive base 141 and suspended above the metal braid 130.

As shown in FIG. 5, in the present embodiments, each of the group of the fins 142 form an L-shaped structure, but the present disclosure is not limited thereto.

As shown in FIG. 5, in the present embodiment, the fins 142 surround to form a plurality of giving way areas 142a above the conductive base 141. The fins 142 are outside the giving way areas 142a. The fins 142 are sequentially arranged in a lateral direction D based on a pitch P, and a width W of the giving way areas 142a is greater than the pitch P.

In the example as shown in FIG. 5, a number of the giving way areas 142a is four, but the present disclosure is not limited thereto.

As shown in FIG. 5, in the present embodiment, the conductive base 141 has a rear edge 141a away from the outer terminal 122. One of the giving way areas 142a extends to the rear edge 141a. In addition, the high power cable harness 100 further includes a thermal sensor 160 disposed in the one of the giving way areas 142a. An end of a wire 161 is connected to the thermal sensor 160, and the wire 161 extends beyond the rear edge 141a. Another end of the wire 161 is connected to a signal transmission connector 162. The thermal sensor 160 is configured to measure the temperature of the heat sink 140 and transmit the measured temperature data to a controller (not shown) sequentially via the wire 161 and the signal transmission connector 162. When the temperature exceeds the set value, an alarm may be triggered or a cooling system may be activated to prevent components from being damaged due to overheating. In an example, the thermal sensor 160 is a thermistor, but the present disclosure is not limited thereto.

As shown in FIG. 4, in the present embodiment, the high power cable harness 100 further includes a plurality of fastening members 150 and a plurality of nuts 152. Two of the fastening members 150 sequentially pass through two of the giving way areas 142a respectively, the power-supplying conductor 131, the outer terminal 122, the conductive block 123, and the inner terminal 121, and are respectively fastened to two of the nuts 152. The nuts 152 abut against the surface 121b1 of base portion 121b of the inner terminal 121. Other two of the fastening members 150 sequentially pass through other two of the giving way areas 142a respectively and the power-supplying conductor 131, and are fastened to the conductive block 123.

According to the foregoing recitations of the embodiments of the disclosure, it can be seen that in the high power cable harness of the present disclosure, since each of the terminal modules includes the conductive block partially sandwiched between the inner terminal and the outer terminal, and the power-supplying conductor is secured on the outer terminal and thermally connected to the conductive block, a plurality of electrical/thermal conductive paths can be formed. Specifically, a first electrical/thermal conductive path passes through the inner terminal (via the top surface thereof) and the conductive block, a second electrical/thermal conductive path passes through the outer terminal (via the bottom surface thereof) and the conductive block, and a third electrical/thermal conductive path passes through the outer terminal (via the top surface thereof) and the power-supplying conductor. In this way, the electrical/thermal conductivity performance of high power cable harness can be effectively improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A high power cable harness, comprising:
a housing comprising two protruding portions each having an opening, wherein the openings of the protruding portions are opposite to each other;
two terminal modules embedded into the housing, each of the terminal modules comprising:
an inner terminal partially exposed from one of the openings;
an outer terminal partially exposed from the one of the openings; and
a conductive block partially sandwiched between the inner terminal and the outer terminal; and
a power-supplying conductor secured on a side of the outer terminal away from the inner terminal and thermally connected to the conductive block.

2. The high power cable harness of claim 1, wherein each of the inner terminal and the outer terminal comprises a terminal end and a base portion connected to the terminal end, the terminal end is exposed from the one of the openings, the base portion is embedded into the housing, and the conductive block is partially sandwiched between the base portions of the inner terminal and the outer terminal.

3. The high power cable harness of claim 2, wherein the conductive block comprises a front portion and a rear portion connected to each other, the front portion is sandwiched between the base portions of the inner terminal and the outer terminal, and the rear portion is in contact with the power-supplying conductor.

4. The high power cable harness of claim 3, wherein the conductive block has a recess on a side of the conductive block facing the power-supplying conductor, and the base portion of the outer terminal is located at the recess.

5. The high power cable harness of claim 4, wherein a surface of the base portion of the outer terminal away from the inner terminal and a surface of the rear portion facing the power-supplying conductor are coplanar.

6. The high power cable harness of claim 3, wherein the conductive block has a recess on a side of the conductive block away from the power-supplying conductor, and the base portion of the inner terminal is located at the recess.

7. The high power cable harness of claim 6, wherein a surface of the base portion of the inner terminal away from the outer terminal and a surface of the rear portion away from the power-supplying conductor are coplanar.

8. The high power cable harness of claim 2, wherein the terminal end and the base portion of one of the inner terminal and the outer terminal are connected flatly, and the terminal end and the base portion of another of the inner terminal and the outer terminal are connected curvedly.

9. The high power cable harness of claim 1, further comprising a heat sink thermally coupled to the power-supplying conductor.

10. The high power cable harness of claim 9, wherein the heat sink comprises:
a conductive base coupled to a surface of the power-supplying conductor away from the conductive block; and
a plurality of fins connected to the conductive base.

11. The high power cable harness of claim 10, wherein the surface of the power-supplying conductor has a front edge adjacent to the outer terminal, and the conductive base partially extends beyond the front edge.

12. The high power cable harness of claim 10, wherein the surface of the power-supplying conductor has a rear edge away from the outer terminal, and at least one of the fins partially extends beyond the rear edge.

13. The high power cable harness of claim 10, wherein the fins surround to form a giving way area above the conductive base, the fins are sequentially arranged in a lateral direction based on a pitch, and a width of the giving way area is greater than the pitch.

14. The high power cable harness of claim 13, wherein the conductive base has a rear edge away from the outer terminal, and the giving way area extends to the rear edge.

15. The high power cable harness of claim 14, further comprising a thermal sensor disposed in the giving way area, and a wire connected to the thermal sensor extends beyond the rear edge.

16. The high power cable harness of claim 13, further comprising a fastening member sequentially passing through the giving way area, the power-supplying conductor, the outer terminal, the conductive block, and the inner terminal.

17. The high power cable harness of claim 13, further comprising a fastening member sequentially passing through the giving way area and the power-supplying conductor and fastened to the conductive block.

18. A high power cable harness, comprising:
a terminal module comprising:
an inner terminal;
an outer terminal; and
a conductive block partially sandwiched between the inner terminal and the outer terminal;
a power-supplying conductor secured on a side of the outer terminal away from the inner terminal and thermally connected to the conductive block; and
a heat sink thermally coupled to the power-supplying conductor.

19. The high power cable harness of claim 18, wherein each of the inner terminal and the outer terminal comprises a terminal end and a base portion connected to the terminal end, and the conductive block is partially sandwiched between the base portions of the inner terminal and the outer terminal.

20. The high power cable harness of claim 19, wherein the conductive block has a recess on a side of the conductive block facing the power-supplying conductor, the base portion of the outer terminal is located at the recess, and a surface of the base portion of the outer terminal away from the inner terminal and a surface of the conductive block facing the power-supplying conductor are coplanar.
